(19) United States
(12) Patent Application Publication
(10) Pub. No.: US 2004/0015440 A1
(43) Pub. Date: Jan. 22, 2004

(54) Network resource management system

(76) Inventors: Yu Cheng Lai, Chung-Li City (TW); Pang-Ming Huang, Chung-Li City (TW)

Correspondence Address: TROXELL LAW OFFICE PLLC, SUITE 1404, 5205 LEESBURG PIKE, FALLS CHURCH, VA, 22041, US

(21) Appl. No.: 10/198,144

(22) Filed: Jul. 19, 2002

(51) Int. Cl. G06F 17/60

(52) U.S. Cl. 705/50

(57) ABSTRACT

A network resource management system includes: a server a server for constructing therein a database and connection with web sites; an encoder disposed in the server for encoding files downloaded via the server so as to convert the file into an encrypted format; and a decoding software disposed in the computer at a client user end for checking identity and code of the client user against identity in the server and decoding the downloaded file to recover the same into the original file format; whereby all the files downloaded from the server are in an encoded encrypted format upon entering into the computer at the client user end and cannot be displayed in the original file format, and the files have to be encoded to the original format by exclusive decoding software after legitimate licensing and transaction verification for use by the client user, thereby effectively preventing adaptation of network resources.

### BACKGROUND OF THE INVENTION

(a) Field of the Invention

This invention provides a network resource management system to effectively prevent adaptation of network resources and ensure the interest of owners of intellectual property rights. In addition to providing effective management of network resources, the mode thereof can be commonly applied in the agency of electronic publication and network resources.

(b) Description of the Prior Art

In the modern society where network information prospers, many cultural resources in the form of words, graphics, music or even images, can be converted into digital file format for collection and management, which can increase the storage capacity of databases and can be propagated via the network. Ordinary network users can use their personal computers to directly open files received and downloaded over the network so as to immediately share the network resources. Particularly, through the connection between a network server and the computer, the original resource can be browsed, downloaded or even adapted by many people at the same time through different entry web sites.

Therefore, many people obtain the text, graphics, music or image data they need via the Internet. For this reason, when there is not a good management mechanism to manage the Internet resources, the network resources will be stolen or misappropriated, or the resources may be disseminated so that the interests of owners of intellectual properties are jeopardized. Some people enterprises do not put their resources on the network for browsing by others in order to protect the resources they created, which fail to exploit the features of network to achieve promotional effects.

### SUMMARY OF THE INVENTION

Therefore, the primary object of the invention is to dispose an encoder in a server for encoding the files downloaded via the server so as to convert the file into an encrypted format. The user can, through legitimate licensing and transaction verification, open an exclusive decoding software in the computer thereof so that all the files downloaded from the server are in an encoded encrypted format upon entering the computer at the client user end and cannot be displayed in the original file format. The file has to be decoded by the exclusive decoding software for use by the user after the user has obtained legitimate licensing and transaction verification, thereby effectively preventing adaptation of network resources.

Another object of the invention is to provide an encoder to encode in advance the files downloaded via the server such that the file is in an encrypted format, so that the file can be displayed in the web page for browsing by users entering the web pages to thereby achieve a promotional effect. The user can download the file if necessary, and the downloaded file is transmitted via the Internet for storage in the computer of the client user in an encrypted format. If the client user intends to use the file resource, the downloaded file can be decoded using the decoding software into the original format after going through legitimate licensing and transaction verification for use by the client user. There is no need to worry about abuse of the network resources.

A further object of the invention is that the decoding software, when performing verification of the identity of the client user with the server, can transmit the hardware features of the computer of the client user to the server for registration so that the resource management system can have the function of checking the hardware of the computer of the client user so as to prevent counterfeiting of the identity of the client user or to further achieve the exclusiveness of the person to decode after transaction of the work, thereby preventing dissemination of duplication.

A further object of the invention is to construct complete and diverse electronic digital file formats of txt, jpg, gif, rtf, etc., and, through integration with system platform, facilitates application in electronic publication.

A further object of the invention is to enable the client user to directly browse the data provided by data providers of cultural enterprises, organizations or individuals through construction of search engines, and provide transaction verification between the client user and the data providers so as to be applied in the agency of network data.

A further object of the network resource management system of the invention is that the data provider linked to the system can convert their file data into encoded encrypted format beforehand for direct dissemination of the file in the form of electronic mails or optical disks and the like without going through encryption by the system.

### BRIEF DESCRIPTION OF THE DRAWING

FIG. 1 is a flow chart of the system of the invention for use in electronic publication.

### DESCRIPTION OF THE INVENTION

The invention includes: a server for construction of a database therein and connection with web sites; an encoder disposed in the server for real time encoding or pre-encoding in a conventional computer for encoding digital works to be sold so as to convert the file into an encrypted format; a decoding software disposed in the computer at the client user end to perform checking of identity and code keyed in by the client user against identity in the server, or perform decryption of decryption word string corresponding to the file, and perform decoding algorithm of the downloaded file so as to convert it into the original file format; particularly, when the decoding software performs verification of the identity of the client user with the server, it can simultaneously transmit the hardware features of the client computer back to the server to combine and operate with the encryption word string of the digital work to form a new word string. The new word string is written into the client user end so that the work cannot be duplicated for reading by other hardware, thereby effectively preventing the work from being copied.

Therefore, the file downloaded from the server is in an encrypted format that has been encoded upon entering the computer at the client user end, and cannot be displayed in the original file format. The file can be used by the client user only the client has obtained legitimate licensing and transaction verification, and the file has been decoded and recovered via exclusive decoding software, thereby effectively preventing network resources from being adapted.

Furthermore, the server can, through the provision of web pages, allow users entering into the system web pages to perform data searches, browsing, and, through construction of search engines and linking with entry web sites, allow the user to browse the data provided data providers including cultural enterprises, organizations, individuals. If necessary, the user can immediately download the file after browsing, the downloaded file is transmitted via the Internet transmission or any transmission medium, such as CD or floppy disk for storage in the client user computer in an encoded encrypted format. When the user desires to use the file data, the downloaded file has to be recovered, through legitimate licensing and transaction verification, via exclusive decoding software to the original format before it can be used. Resource providers do not have to worry about abuse of the resources on their web pages, and can utilize the Internet to achieve the desired promotional effects.

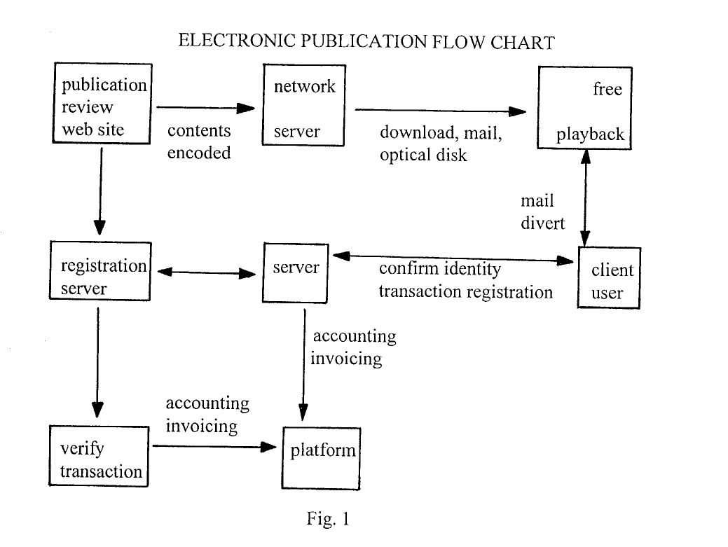

Furthermore, since the system constructs a complete and diverse electronic digital file format databases, such as text, jpg, gif, rtf, in the server, and can connect with entry web sites and other databases, it can have the form as shown in FIG. 1 to integrate with a system platform so as to facilitate use in electronic publication. Certainly, the file used thereby can be transmitted in the form of recorded optical disk after encoding, and, when the decoding software performs verification of the client user identity with the server, it can simultaneously transmit the hardware features of the client user computer back to the server for registration such that the present resource management system can have the function of checking of the hardware of the client user computer, thereby effectively preventing counterfeiting of the client user identity.

More particularly, in actual application, through the construction of search engines and connection with entry web sites, the system enables client users to browse data provided by data providers including cultural enterprises, organizations and individuals, and provides an intermediary transaction verification between the client user and the data provider so as to be applied in the agency of network data. Certainly, the data providers connected with this system can also convert the file data into encoded encrypted format beforehand for direct downloaded by client users of the system without the need to perform encryption by the system.

In the invention, by means of providing an encoder in the server to encode a file downloaded via the server so as to convert the file into an encrypted format, and the user, through legitimate licensing and transaction verification, can open an exclusive decoding software in the computer thereof so that all the files downloaded from the server are in an encoded encrypted format upon entering the computer at the client user end and cannot be displayed in the original file format. The file has to be decoded by the exclusive decoding software after legitimate licensing and transaction verification for use by the client user, thereby effectively preventing adaptation of network resources and ensuring the interests of owners of intellectual property rights.

What is claimed is:

1. A network resource management system, comprising: a server for constructing therein a database and connection with web sites; an encoder disposed in said server for encoding files downloaded via said server so as to convert the file into an encrypted format; and a decoding software disposed in the computer at a client user end for checking identity and code of the client user against identity in said server and decoding the downloaded file to recover the same into the original file format;
whereby all the files downloaded from said server are in an encoded encrypted format upon entering into the computer at the client user end and cannot be displayed in the original file format, and the files have to be encoded to the original format by exclusive decoding software after legitimate licensing and transaction verification for use by the client user, thereby effectively preventing adaptation of network resources.

2. The system of claim 1, wherein said decoding software performs verification of the identity of the client user with said server, it can transmit the hardware features of the client user computer to said server for registration such that said resource management system can have the function of checking the hardware of the client user computer, thereby effectively preventing counterfeiting of the identity of the client user.

3. The system of claim 1, wherein said server is capable of constructing complete and diverse electronic digital file formats of text, jpg, gif, rtf, and, through connection with entry web sites and other database, and integration with system platform, facilitates application in digital electronic publication.

4. The system of claim 1, wherein said system can, through construction of search engines and connection with entry web sites, and any carrier that can mediate digital resources, enables the client user to directly browse data provided by data providers of cultural enterprises, organizations or individuals, and provides transaction verification between the client user and the data provider so as to be applied in the agency of network data.

5. The system of claim 1, wherein said decoding software can perform decryption algorithm according to the identity code keyed in by the client user and the decryption word string corresponding to the file in said server, and decode the downloaded file to convert the same into the original file format.

6. The system of claim 1, wherein said decoding software, when performing verification of the identity of the client user with said server, transmit the hardware features of the computer at the client user end to said server to combine with encryption word string of the work for writing at the client user end.

7. The system of claim 4, wherein said data provider linked to said system can convert their file data into encoded encrypted format beforehand for direct dissemination of the file in the form of electronic mails or optical disks and the like without going through encryption by said system.
